(19) United States
(12) Patent Application Publication
(10) Pub. No.: US 2015/0208090 A1
(43) Pub. Date: Jul. 23, 2015

(54) IMAGE ENCODING APPARATUS AND IMAGE ENCODING METHOD

(71) Applicant: PANASONIC INTELLECTUAL PROPERTY MANAGEMENT CO. LTD., Osaka (JP)

(72) Inventors: Kazuma SAKAKIBARA, Osaka (JP); Kiyofumi ABE, Osaka (JP); Hideyuki OHGOSE, Osaka (JP); Koji ARIMURA, Osaka (JP); Hiroshi ARAKAWA, Tokyo (JP); Kazuhito KIMURA, Shiga (JP)

(21) Appl. No.: 14/673,816

(22) Filed: Mar. 30, 2015

Related U.S. Application Data
(63) Continuation of application No. PCT/JP2013/005811, filed on Sep. 30, 2013.

(30) Foreign Application Priority Data
Oct. 1, 2012 (JP) 2012-219109

(51) Int. Cl. H04N 19/593; H04N 19/182; H04N 19/176; H04N 19/11

(52) U.S. Cl. CPC H04N 19/593; H04N 19/11; H04N 19/182; H04N 19/176

(57) ABSTRACT

An image encoding apparatus which encodes an input image includes: an intra prediction unit which performs intra prediction on a per-sub-block basis. The intra prediction unit includes: a size determining unit which determines whether the size of a current sub-block is less than or equal to a predetermined size; a candidate determining unit which determines m intra prediction modes (where m is a natural number) as candidate prediction modes when the size of the current sub-block is determined to be less than or equal to the predetermined size, the m intra prediction modes being less than M intra prediction modes predefined independently of the block size (where M is a natural number greater than or equal to 2); and a prediction unit which selects one of the candidate prediction modes and performs intra prediction on the current sub-block using the selected intra prediction mode.

### CROSS REFERENCE TO RELATED APPLICATIONS

This is a continuation application of PCT International Application No. PCT/JP2013/005811 filed on Sep. 30, 2013, designating the United States of America, which is based on and claims priority of Japanese Patent Application No. 2012-219109 filed on Oct. 1, 2012. The entire disclosures of the above-identified applications, including the specifications, drawings and claims are incorporated herein by reference in their entirety.

### FIELD

The present disclosure relates to image encoding methods and image encoding apparatuses.

### BACKGROUND

High efficiency video coding (HEVC) has been currently studied as a next-generation image coding standard of H.264. As FIG. 1 illustrates, the HEVC defines 35 types of intra prediction modes selectable in intra prediction. In the HEVC, coding is performed using the 35 types of intra prediction modes.

However, when a block to be intra-predicted has a small size such as 4×4 pixels, some adjacent intra prediction modes use the same reference pixel to perform intra prediction. In the intra predictions with the same reference pixel, the resulting values of residual image signals are approximately the same even in different intra prediction modes.

### CITATION LIST

### Non Patent Literature

[NPL 1] Joint Collaborative Team on Video Coding (JCT-VC) of ITU-T SG16 WP3 and ISO/IEC JTC1/SC29/WG, 10th Meeting Stockholm, SE, 11-20 Jul. 2012, Document JCTVC-J1003_d7

### SUMMARY

### Technical Problem

Intra prediction having many available intra prediction modes as above allows detailed prediction to be performed, which leads to increased image quality or coding efficiency. However, for example, when a sub-block to be predicted has a small size such as 4×4 pixels and the values of residual image signals obtained as intra prediction results are approximately the same, the image quality or coding efficiency cannot be significantly increased. In such a case, only the amount of processing for intra prediction simply increases.

The present disclosure provides an image encoding apparatus and an image encoding method which reduces decrease in coding efficiency and reduces the amount of processing required for intra prediction.

### Solution to Problem

An image encoding apparatus according to the present disclosure is an image encoding apparatus which encodes an input image. The image encoding apparatus includes: a dividing unit which divides a current block to be encoded in the input image into a plurality of sub-blocks; and an intra prediction unit which performs intra prediction on the plurality of sub-blocks generated by the dividing unit, on a per-sub-block basis. The intra prediction unit includes: a size determining unit which determines whether or not a current sub-block to be predicted among the plurality of sub-blocks has a size less than or equal to a predetermined size; a candidate determining unit which determines m intra prediction modes as one or more candidate prediction modes when the size determining unit determines that the current sub-block has the size less than or equal to the predetermined size, m being a natural number greater than or equal to 1, the m intra prediction modes being less than M intra prediction modes predefined independently of the size of the current sub-block, M being a natural number greater than or equal to 2; and a prediction unit which selects one intra prediction mode from among the one or more candidate prediction modes determined by the candidate determining unit and performs intra prediction on the current sub-block using the one intra prediction mode selected.

### Advantageous Effects

An image encoding apparatus and an image encoding method according to the present disclosure reduces decrease in coding efficiency and reduce the amount of processing required for intra prediction.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 illustrates different types of intra prediction modes defined in the HEVC standard.

FIG. 2 is a block diagram illustrating a configuration of an image encoding apparatus according to an embodiment.

FIG. 3 is a block diagram illustrating a configuration of an intra prediction unit according to the embodiment.

FIG. 4 is a flowchart of an operation of intra prediction according to the embodiment.

FIG. 5 illustrates pixel positions of a current sub-block to be predicted according to the embodiment.

FIG. 6 illustrates neighboring pixels to be referred to by the bottom-right-most pixel in intra prediction of a sub-block of 4×4 pixels according to the embodiment.

FIG. 7A is a diagram for illustrating an operation for limiting the number of intra prediction modes with use of identification numbers according to the embodiment.

FIG. 7B is a diagram for illustrating an operation for limiting the number of intra prediction modes with use of identification numbers according to the embodiment.

FIG. 8 is a diagram for illustrating an operation for limiting the number of intra prediction modes with use of angles formed by prediction directions according to Variation 1 of the embodiment.

FIG. 9 is a diagram for illustrating an operation for limiting the number of intra prediction modes so as to make a planar prediction mode and a DC prediction mode available according to Variation 2 of the embodiment.

FIG. 10 illustrates an operation for limiting the number of intra prediction modes so as to make intra prediction modes having horizontal and vertical predictions available according to Variation 3 of the embodiment.

FIG. 11 is a diagram for illustrating an operation for limiting the number of intra prediction modes based on frequency of use of intra prediction modes according to Variation 4 of the embodiment.

FIG. 12 is a flowchart of an operation for limiting the number of intra prediction modes based on an edge according to Variation 5 of the embodiment.

FIG. 13 illustrates combinations of reference pixels used in two intra prediction modes according to Variation 6 of the embodiment.

### DESCRIPTION OF EMBODIMENTS

Hereinafter, non-limiting embodiments will be described in detail with reference to the accompanying drawings. Unnecessarily detailed description may be omitted. For example, detailed descriptions of well-known matters or descriptions previously set forth with respect to structural elements that are substantially the same may be omitted. This is to avoid unnecessary redundancy in the descriptions below and to facilitate understanding by those skilled in the art.

It should be noted that the inventors provide the accompanying drawings and the description below for a thorough understanding of the present disclosure by those skilled in the art, and the accompanying drawings and the descriptions are not intended to be limiting the subject matter recited in the claims appended hereto.

### Embodiment

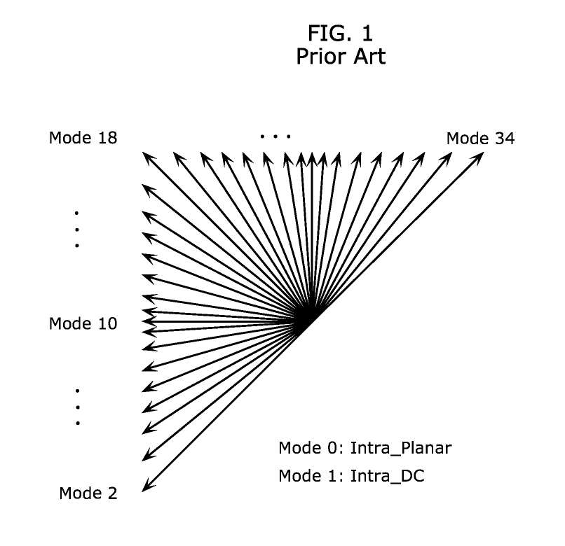

Hereinafter, an embodiment will be described with reference to FIGS. 1 to 13. For the purpose of illustration, an operation for performing encoding according to the HEVC will be described.

### Configuration of Image Encoding Apparatus

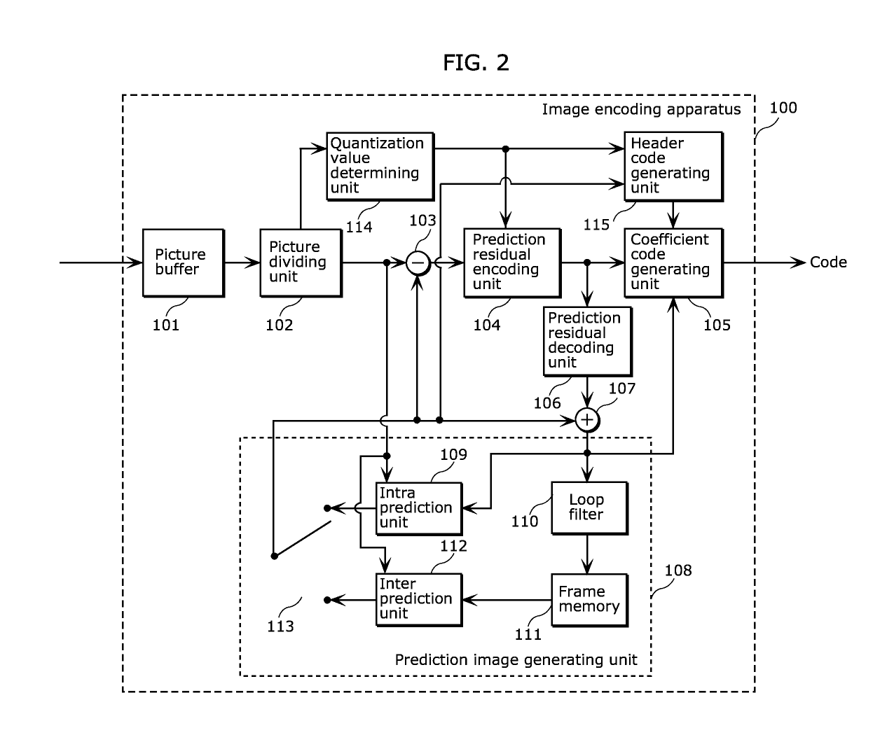

FIG. 2 is a block diagram of an image encoding apparatus 100 according to the present embodiment.

The image encoding apparatus 100 divides a moving image provided on a per picture basis into blocks (blocks to be encoded), and performs encoding on a per block basis to generate a code. Each block includes a plurality of sub-blocks. Each of structural elements of the image encoding apparatus 100 performs processing on a per block basis or a per sub-block basis.

The image encoding apparatus 100 illustrated in FIG. 2 includes a picture buffer 101, a picture dividing unit 102, a subtracting unit 103, a prediction residual encoding unit 104, a coefficient code generating unit 105, a prediction residual decoding unit 106, an adding unit 107, a prediction image generating unit 108, a quantization value determining unit 114, and a header code generating unit 115. The prediction image generating unit 108 includes an intra prediction unit 109, a loop filter 110, a frame memory 111, an inter prediction unit 112, and a selecting unit 113.

The image encoding apparatus 100 performs compression encoding on an input image according to the HEVC standard to generate and provide a code.

The picture buffer 101 is an example of an obtaining unit. The picture buffer 101 obtains the input image, and temporarily stores the obtained input image onto a storage medium. For example, the picture buffer 101 rearranges the input image provided on a per picture basis in display order, according to an encoding order when storing the pictures. Any storage medium for storing the input image, such as a dynamic random access memory (DRAM) may be used as a storage medium in the picture buffer 101.

The picture dividing unit 102 is an example of a dividing unit for dividing a current block to be encoded in the input image into a plurality of sub-blocks. When the picture dividing unit 102 receives a read instruction from the subtracting unit 103 or the quantization value determining unit 114, the picture dividing unit 102 obtains the input image from the picture buffer 101. The picture dividing unit 102 then provides an image signal corresponding to the read instruction to the subtracting unit 103.

Here, each picture is divided into coding units (CUs) each of which is a unit of coding processing and includes a plurality of pixels. A CU is an example of a current block to be encoded, and is, for example, a block of 64×64 pixels, 32×32 pixels, or 16×16 pixels.

The subtracting unit 103 generates a residual image signal by calculating a difference between a current block provided from the picture dividing unit 102 and a prediction image which is a prediction image of the current block to be provided from the prediction image generating unit 108. For example, the subtracting unit 103 calculates a difference on a per current block basis. The subtracting unit 103 provides the residual image signal to the prediction residual encoding unit 104. Specifically, the subtracting unit 103 generates a residual image signal which is a difference value between the image signal read from the picture dividing unit 102 and the prediction image signal to be provided from the prediction image generating unit 108, and provides the generated signal to the prediction residual encoding unit 104.

The prediction residual encoding unit 104 performs orthogonal transform on the residual image signal provided from the subtracting unit 103 to generate orthogonal transform coefficients. The prediction residual encoding unit 104 performs orthogonal transform on the residual image signal on a per orthogonal-transform-sub-block basis. Here, the orthogonal-transform-sub-block is an orthogonal transform processing unit which is referred to as a transform unit (TU) and which includes a plurality of pixels. For example, the orthogonal-transform-sub-block (TU) is a block of 32×32 pixels, 16×16 pixels, 8×8 pixels, or 4×4 pixels.

The prediction residual encoding unit 104 further quantizes each of frequency components of resulting orthogonal transform coefficients to generate a quantization coefficient. The prediction residual encoding unit 104 provides the quantization coefficient to the coefficient code generating unit 105 and the prediction residual decoding unit 106. The prediction residual encoding unit 104 quantizes the orthogonal transform coefficient using a quantization value signal determined by the quantization value determining unit 114.

The coefficient code generating unit 105 performs variable length encoding on the quantization coefficient provided from the prediction residual encoding unit 104. The coefficient code generating unit 105 writes the code generated through variable length encoding, next to the code generated by the header code generating unit 115. In this way, the coefficient code generating unit 105 generates a code signal to be provided.

The prediction residual decoding unit 106 performs inverse quantization and inverse orthogonal transform on the quantization coefficient provided from the prediction residual encoding unit 104 to reconstruct a decoded residual signal. The prediction residual decoding unit 106 provides the resulting decoded residual signal to the adding unit 107.

The adding unit 107 adds the decoded residual signal provided from the prediction residual decoding unit 106 and a prediction image to be provided from the prediction image generating 108 to generate a reconstructed image signal. The adding unit 107 provides the reconstructed image signal to the intra prediction unit 109 and the loop filter 110.

The prediction image generating unit 108 generates a prediction image corresponding to a block to be provided from the picture dividing unit 102, at least based on the reconstructed image signal provided from the adding unit 107. The prediction image generating unit 108 performs intra prediction or inter prediction to generate a prediction image.

The prediction image generating unit 108 generates a prediction image on a per prediction-sub-block basis. Here, a prediction-sub-block is a prediction processing unit which is referred to as a prediction unit (PU) and which includes a plurality of pixels. For example, the prediction-sub-block (PU) indicates each area generated by dividing the current block provided from the picture dividing unit 102 into one or more areas. For example, a PU is a block of 64×64 pixels, 32×32 pixels, 16×16 pixels, 8×8 pixels, or 4×4 pixels.

The prediction image generating unit 108 switches between intra prediction and inter prediction per current block provided from the picture dividing unit 102. In other words, either one of intra prediction or inter prediction is applied to each sub-block in the current block.

The prediction image generating unit 108 includes the intra prediction unit 109, the loop filter 110, the frame memory 111, the inter prediction unit 112, and the selecting unit 113.

The intra prediction unit 109 generates a prediction image of the current block on a per prediction-sub-block basis, using pixel data of pixels located near the current block and in already encoded blocks. Specifically, the intra prediction unit 109 generates a prediction image by performing intra prediction at least based on the already encoded pixel data adjacent to the current block.

The intra prediction unit 109 selects one of 35 intra prediction modes defined in the HEVC that is a coding standard supported by the image encoding apparatus 100. Furthermore, the intra prediction unit 109 performs intra prediction based on the selected intra prediction mode to generate a prediction image of a current sub-block to be predicted. The intra prediction unit 109 provides a prediction image of a block provided from the picture dividing unit 102, to the subtracting unit 103 and the adding unit 107. The prediction image of the block is obtained as a result of generating a prediction image on a per sub-block basis.

A detailed description of the configuration and operation of the intra prediction unit 109 will be given later.

The loop filter 110 performs filtering on the reconstructed image signal provided from the adding unit 107. For example, the loop filter 110 performs filtering on the reconstructed image signal to reduce block noise. The loop filter 110 provides the filtered reconstructed image signal to the frame memory 111.

The frame memory 111 stores the filtered reconstructed image signal provided from the loop filter 110. The reconstructed image signal is used in prediction encoding in encoding pictures subsequent to the current picture. In other words, the reconstructed image signal is used as pixel data in generating a prediction image using inter prediction when encoding pictures subsequent to the current picture. The frame memory 111 provides the stored reconstructed image signal as pixel data to the inter prediction unit 112 in response to a read instruction from the inter prediction unit 112.

The inter prediction unit 112 performs inter prediction using the reconstructed image signal stored in the frame memory 111 as a reference image to generate a prediction image signal for each sub-block. In inter prediction, a reconstructed image signal of an encoded picture stored in the frame memory 111 is used. The inter prediction unit 112 provides the generated prediction image signal to the subtracting unit 103 and the adding unit 107.

The selecting unit 113 selects either one of the intra prediction or the inter prediction based on the coding amount or a prediction value of a residual image signal obtained as a result of the prediction. Specifically, the selecting unit 113 selects intra prediction when the coding amount or the prediction value of the residual image signal obtained by intra prediction is small. The selecting unit 113 selects inter prediction when the coding amount or the prediction value of the residual image signal obtained by intra prediction is large.

The prediction image generating unit 108 need not necessarily perform inter prediction. In this way, the prediction image generating unit 108 can simplify the processing when only intra prediction is used for a still image and the like.

The quantization value determining unit 114 sets a quantization value (a quantization size) to be used to quantize a residual image signal in the prediction residual encoding unit 104, based on a picture read by the picture dividing unit 102 from the picture buffer 101. The quantization value determining unit 114 provides the set quantization value to the prediction residual encoding unit 104 and the header code generating unit 115. The quantization value determining unit 114 may set a quantization value based on rate control. The rate control is performed to approximate a bit rate of an encoded signal to a target bit rate.

The header code generating unit 115 generates codes by performing variable length encoding on a prediction information signal provided by the prediction image generating unit 108, a quantization value signal provided by the quantization value determining unit 114, and control information related to other coding control, to generate codes. The prediction information includes, for example, information indicating an intra prediction mode, an inter prediction mode, a motion vector, and a reference picture. In addition, the control information is obtainable before processing in the coefficient code generating unit 105, and indicates a coding condition applied in the encoding of a block. For example, control information includes a picture encoding type or block division information. For example, a picture encoding type is information indicating an I-picture, a P-picture, or a B-picture, or information related to a prediction method applied to a block. The block division information includes, for example, division information on a sub-block in orthogonal transform or division information on a sub-block in intra prediction unit 108.

### Configuration of Intra Prediction Unit

A detailed description of the configuration of the intra prediction unit 109 will be given below.

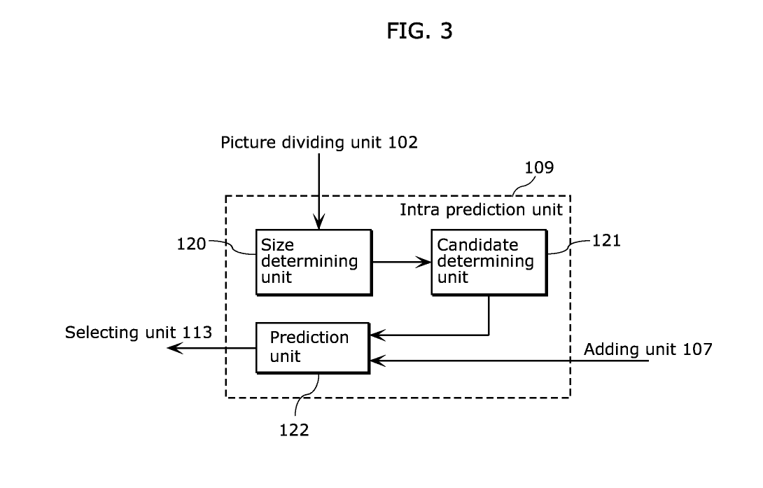

FIG. 3 is a block diagram of the intra prediction unit 109 according to the present embodiment. The intra prediction unit 109 includes a size determining unit 120, a candidate determining unit 121, and a prediction unit 122.

The size determining unit 120 determines whether or not a current sub-block to be predicted has a size less than or equal to a predetermined size. In other words, the size determining unit 120 determines whether or not the size of the current sub-block is small. Specifically, the predetermined size is 4×4 pixels. The size determining unit 120 determines that the size of the current sub-block is small when the size of the current sub-block is less than or equal to 4×4 pixels. More specifically, the size determining unit 120 determines that the size of the current sub-block to be small only when the current sub-block obtained from the picture dividing unit 102 is 4×4 pixels.

The predetermined size is not limited to the above example. For example, the predetermined size may be 8×8 pixels. In other words, the size determining unit 120 may determine that the current sub-block to be small when the size of the current sub-block is less than or equal to 8×8 pixels.

When the size determining unit 120 determines that the size of the current sub-block is less than or equal to the predetermined size, the candidate determining unit 121 determines, as candidate intra prediction modes, m intra prediction modes that is less than M intra prediction modes predefined independently of the block size. Here, m is a natural number and M is a natural number greater than or equal to 2. The candidate determining unit 121 determines M intra prediction modes predefined independently of the block size as the candidate prediction modes when the size determining unit 120 determines that the size of the current sub-block is greater than the predetermined size.

Here, M intra prediction modes are intra prediction modes defined according to a predetermined coding standard. Specifically, M intra prediction modes are defined according to the HEVC. As FIG. 1 illustrates, the HEVC defines 35 intra prediction modes. Specifically, M is 35.

The method of determining m intra prediction modes performed by the candidate determining unit 121 will be described later with specific examples.

The prediction unit 122 selects one prediction mode from among the candidate prediction modes determined by the candidate determining unit 121, and performs intra prediction on the current sub-block using the selected intra prediction mode. For example, the prediction unit 122 performs intra prediction using the encoded pixel data provided from the adding unit 107. The prediction unit 122 generates a prediction image by performing intra prediction, and provides the generated prediction image to the selecting unit 113.

### Intra Prediction

Hereinafter, referring to the drawings, an image encoding method according to the present embodiment will be described. A description will be given mainly to intra prediction performed by the intra prediction unit 109.

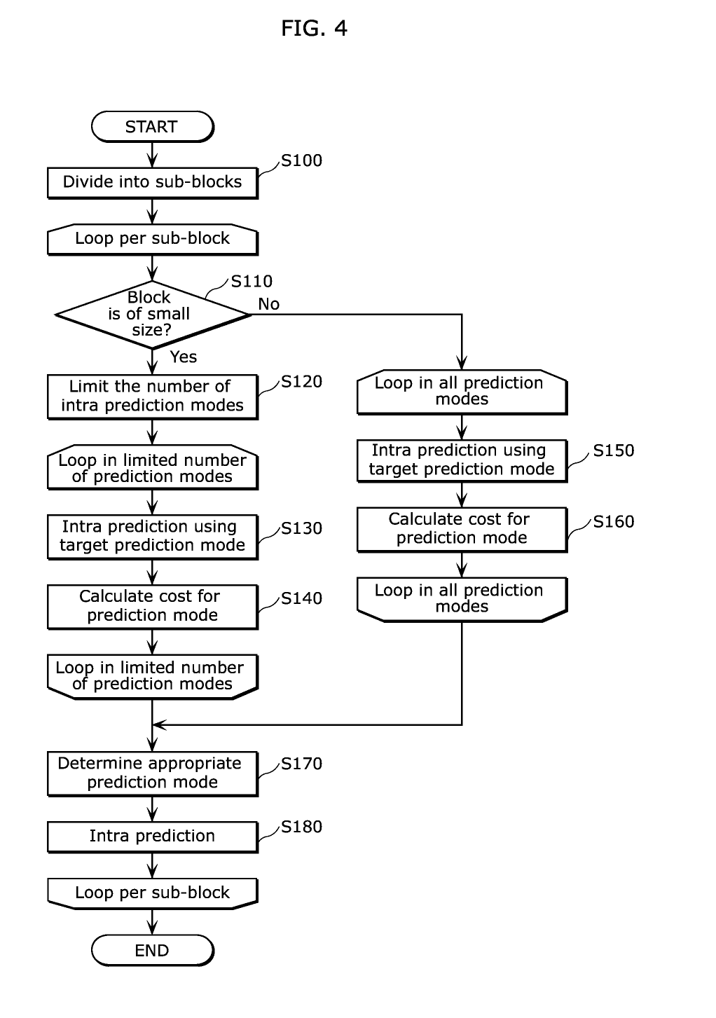

FIG. 4 is a flowchart of an operation of intra prediction according to the present embodiment.

The picture dividing unit 102 divides a current block to be encoded in an input image into a plurality of sub-blocks (S100). The intra prediction unit 109 performs intra prediction on a per sub-block basis.

The size determining unit 120 determines whether or not the current sub-block has a size less than or equal to a predetermined size (S110). For example, the size (predetermined size) of the sub-block predetermined to serve as a reference for determining the magnitude of the size is 4×4 pixels. The predetermined sub-block size is not limited to the above example, but may be set as desired by a designer to, for example, 8×8 pixels. For the purpose of illustration, the predetermined sub-block size is 4×4 pixels in the following description.

When the size of the current sub-block is determined to be 4×4 pixels (Yes in S110), the candidate determining unit 121 determines m intra prediction modes less than the number of M intra prediction modes as candidate prediction modes (S120). In other words, the candidate determining unit 121 limits the number of M (M=35) intra prediction modes to m. By limiting the number of intra prediction modes to m in this manner, the processing time required for intra prediction for (35−m) intra prediction modes can be reduced.

In the following description, the prediction unit 122 performs intra prediction (S130) and cost calculation (S140) in each of the m intra prediction modes.

Specifically, the prediction unit 122 performs intra prediction using a target prediction mode which is one of the m intra prediction modes (S130). In other words, the prediction unit 122 calculates a prediction value for each pixel in the current sub-block using the target prediction mode. The method of calculating the prediction value will be specifically described later.

The prediction unit 122 calculates a coding cost for the target prediction mode based on the calculated prediction value (S140). For example, the prediction unit 122 calculates a difference value between the prediction value calculated using the target prediction mode and pixel data of the input image as a coding cost. The pixel data is included in the current block and corresponds to the current sub-block.

The prediction unit 122 repeats intra prediction (S130) and cost calculation (S140) using a different prediction mode among the m intra prediction modes as a new prediction mode. In this way, the prediction value and the coding cost are calculated in each of the m intra prediction modes.

The prediction unit 122 determines an appropriate intra prediction mode from m intra prediction modes based on the calculated coding cost (S170). For example, the prediction unit 122 determines an intra prediction mode having the minimum difference value as an appropriate intra prediction mode when the difference value is calculated as an coding cost.

The prediction unit 122 calculates the prediction value by performing intra prediction using the determined intra prediction mode (S180). The prediction unit 122 provides the calculated prediction value to the selecting unit 113. When the prediction value has already been calculated when an appropriate intra prediction mode is determined (S130 and S140), the prediction unit 122 may provide the already calculated prediction value to the selecting unit 113.

On the other hand, when the size of the current sub-block is determined to be greater than 4×4 pixels (No in S110), the prediction unit 122 performs intra prediction (S150) and cost calculation (S160) in all of the intra prediction modes, that is, 35 intra prediction modes.

Specifically, the prediction unit 122 performs intra prediction using a target prediction mode which is one of the M intra prediction modes (S150). The prediction unit 122 calculates a coding cost for the target prediction mode based on the calculated prediction value (S160). For example, the prediction unit 122 calculates, as a coding cost, a difference value between the prediction value calculated using the target prediction mode and pixel data of the input image. The pixel data is included in the current block and corresponds to the current sub-block.

The prediction unit 122 repeats intra prediction (S150) and cost calculation (S160) using a different prediction mode from the M intra prediction modes as a new prediction mode. In this way, the prediction value and the coding cost are calculated for each of the M intra prediction modes.

Subsequently, in a similar manner to the m intra prediction modes, the prediction unit 122 determines an appropriate intra prediction mode (S170), calculates a prediction value using the determined intra prediction mode (S180), and provides the calculated prediction value to the selecting unit 113. When the prediction value has already been calculated when an appropriate intra prediction mode is determined (S150 and S160), the prediction unit 122 may provide the already calculated prediction value to the selecting unit 113.

### Method of Calculating Prediction Value in Intra Prediction

A method of calculating a prediction value in intra prediction will be described below with reference to the drawings.

For the purpose of illustration, intra prediction according to the HEVC will be described below.

As FIG. 1 illustrates, the HEVC defines 35 types of intra prediction modes independently of the size of the block to be predicted. Specifically, the HEVC defines Planar prediction mode, DC prediction mode, and 33 prediction direction modes.

In the HEVC, for example, when the size of the current block is 4×4 pixels, 35 intra prediction modes are available, and when the size of the current block is 8×8 pixels, 35 intra prediction modes are also available. In other words, in the HEVC, when intra prediction is performed, 35 intra prediction modes are available independently of the size of the current block, and one of 35 intra prediction modes can be selected. Since 35 intra prediction modes are defined as candidate prediction modes as described above, the intra prediction unit 109 selects one of 35 intra prediction modes when performing intra prediction.

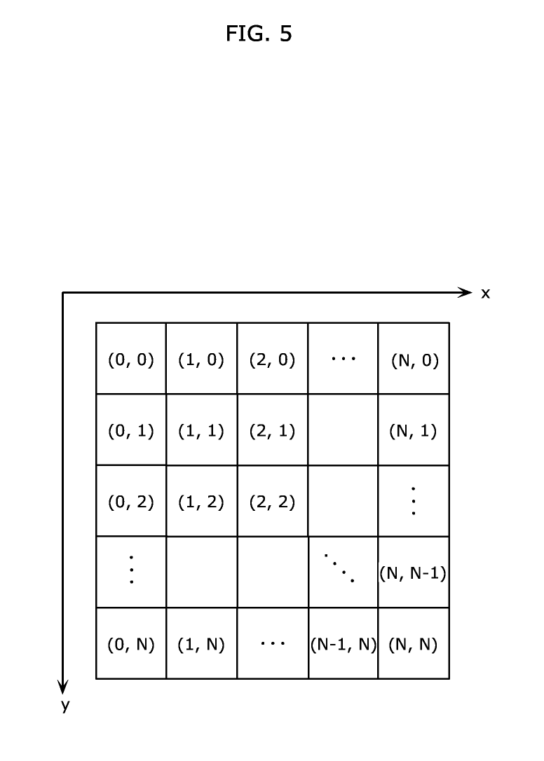

FIG. 5 is a diagram illustrating the pixel positions of a current sub-block to be predicted according to the present embodiment.

As FIG. 5 illustrates, x axis represents a horizontal direction, y axis represents a vertical direction, and positive (+) represents rightward and downward directions. In the following description, the pixel located at coordinates (x, y) is represented as pixel (x, y), and the pixel value thereof is represented as p (x, y). When the size of the current sub-block is 4×4 pixels, N illustrated in FIG. 5 is 3.

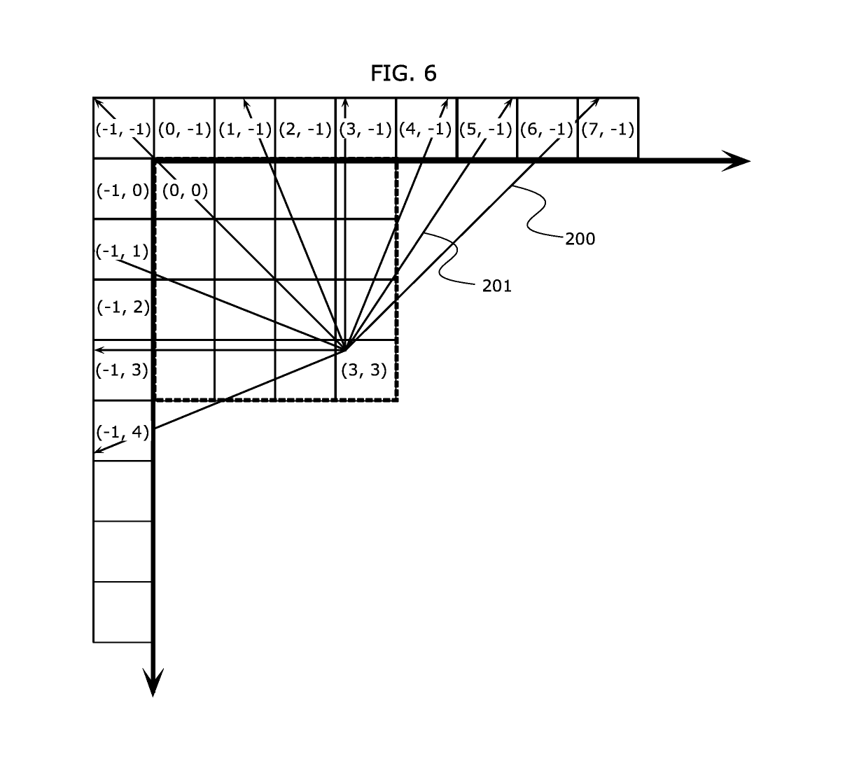

FIG. 6 is a diagram illustrating neighboring pixels to be referred to by the bottom-right-most pixel in intra prediction of a sub-block of 4×4 pixels according to the present embodiment. For the purpose of illustration, a description is given of pixel (3, 3) which is located at the bottom-right most in the 4×4 pixels, but prediction is performed on the pixels at the other positions in a similar manner. The intra prediction unit 109 calculates a prediction value using the following intra prediction mode.

1. Vertical Intra Prediction Mode

In the vertical intra prediction mode, a pixel value of a pixel located straight above the current pixel to be predicted is used as it is as a prediction value. For example, in the vertical intra prediction mode, the prediction value for pixel (3, 3) is pixel value p (3, −1) of pixel (3, −1).

2. Horizontal Intra Prediction Mode

In the horizontal intra prediction mode, a pixel value of a pixel located in the horizontal direction from to the current pixel is used as it is as a prediction value. For example, in the horizontal intra prediction mode, the prediction value for pixel (3, 3) is pixel value p (−1, 3) of pixel (−1, 3).

3. DC Prediction Mode

DC prediction mode is an intra prediction mode where an average value of neighboring pixels is used. For example, in the DC prediction mode, the prediction value for pixel (3, 3) is an average value of neighboring pixels p(−1, 0), p(−1, 1), p(−1, 2), p(−1, 3), p(0, −1), p(1, −1), p(2, −1), and p(3, −1).

In the DC prediction mode, the prediction values for the pixels other than pixel (3, 3) in the 4×4 pixels are the same value as that calculated for pixel (3, 3).

4. Diagonal Intra Prediction Mode

In the diagonal intra prediction mode, one or two pixels adjacent to each other in the direction designated by a diagonal arrow are referred to, and (Equation 1) or (Equation 2) is used.

S(x, y)=p(a) (Equation 1)

S(x, y)=[c×p(a)+d×p(b)+16]>>5 (Equation 2)

For example, in the case of direction 200 illustrated in FIG. 6, the reference pixel is pixel (7, −1). For example, in the case of direction 201 illustrated in FIG. 6, the reference pixels are pixel (5, −1) and pixel (6, −1).

Here, (Equation 1) is used for obtaining prediction value S (x, y) of intra prediction in pixel position (x, y) when the number of reference pixels is one. Here, a is a value indicating the position of a reference pixel set from the prediction direction, and p(a) is the value of the reference pixel.

(Equation 2) is also used for obtaining prediction value S (x, y) of intra prediction in pixel position (x, y), but is used when the number of reference pixels is two. Here, a and b are values indicating the positions of two reference pixels set from the prediction direction, and p(a) and p(b) are the values of adjacent two reference pixels. Moreover, c and d are weighting values multiplied by the two reference pixels respectively.

The HEVC defines a plurality of intra prediction modes having different diagonal directions. In other words, pixels (that is, values of a and b) and weighting values (that is, values of c and d) vary depending on the intra prediction mode used.

5. Planar Prediction Mode

Planar prediction mode is a prediction mode in which interpolation prediction (weight addition) using four pixels is performed. For example, the prediction value for the pixel (3, 3) is a weighted average value of pixel values of four reference pixels, p(−1, 3), p(3, −1), p(−1, 4), and p(4, −1).

In the above description, intra prediction is performed on 4×4 pixels and the prediction values for the pixels are calculated. However, it may be that intra prediction is performed on other sub-block sizes, such as 8×8 pixels and the prediction values are calculated in a similar manner. In the case of diagonal prediction modes, different pixels are used even in the same intra prediction mode depending on the size of the sub-block.

### Method of Limiting the Number of Intra Prediction Modes

Referring to the drawings, a description will be given of a method of limiting the number of intra prediction modes, that is, a method of determining candidate prediction modes. For the purpose of illustration, a description is given to processing according to the HEVC coding standard.

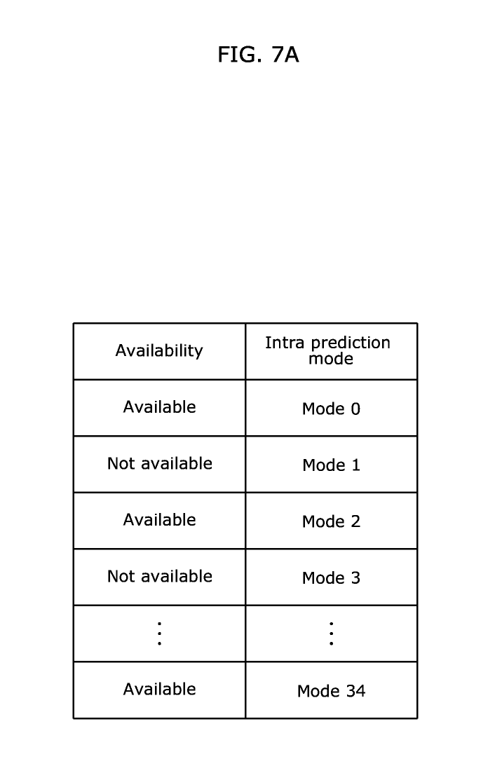

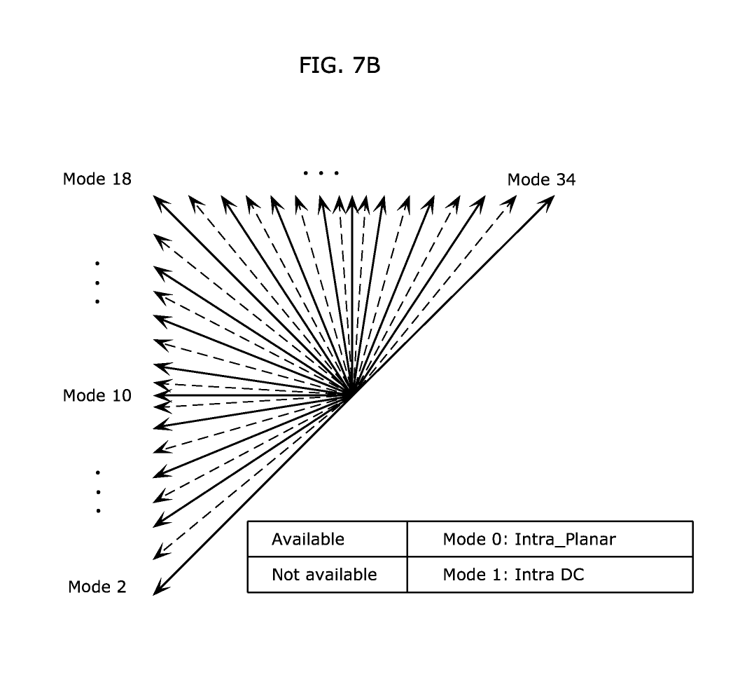

FIG. 7A and FIG. 7B are diagrams for illustrating operations for limiting the number of intra prediction modes with use of identification numbers according to the present embodiment. Specifically, FIG. 7A illustrates a table which associates intra prediction modes and availability. FIG. 7B illustrates a relationship between unavailable intra prediction modes and available intra prediction modes. For the purpose of illustration, in FIG. 7B, the dashed arrows represent unavailable intra prediction modes and the solid arrows represent available intra prediction modes. The same will apply to subsequent drawings as well.

The candidate determining unit 121 determines, as candidate prediction modes, m intra prediction modes having identification numbers at equally spaced intervals. The identification numbers are assigned to the M intra prediction modes to uniquely identify the M intra prediction modes. Specifically, the identification numbers are numbers of 0 to 34 as illustrated in FIG. 1. The candidate determining unit 121 determines m intra prediction modes having identification numbers at equally spaced intervals, that is, the identification numbers forming an arithmetic progression.

For example, as FIG. 7A and FIG. 7B illustrate, the candidate determining unit 121 sets the intra prediction modes defined according to the coding standard such that the intra prediction modes with even numbers are available and the intra prediction modes with odd numbers are unavailable. In other words, the candidate determining unit 121 determines the intra prediction modes defined by even numbers as candidate prediction modes. Here, 0 is an even number.

It is to be noted that m intra prediction modes determined as candidate prediction modes from among M intra prediction modes are predetermined. In other words, the types of m intra prediction modes, and the number of m intra prediction modes (the value of m) are statically determined. For example, the types and the number of m intra prediction modes are determined independently of the type of an input image, such as a still image, a moving image, a natural image, or a text image, and independently of the size of the encoding processing unit, such as the size of the current block to be encoded or the size of the current sub-block to be predicted. Specifically, it is predetermined that the intra prediction modes defined by even numbers are determined as candidate prediction modes when the size of the current sub-block is determined to be small.

In the intra prediction modes having horizontal, vertical, and diagonal prediction directions among intra prediction modes, the current pixel to be predicted refers to neighboring pixels in the prediction direction indicated by the selected intra prediction mode toward the neighboring sub-blocks. Accordingly, when the size of the current sub-block is small such as 4×4 pixels, the angles formed by the prediction directions indicated by intra prediction modes are less than that in the conventional coding standard of H.264. Hence, the same neighboring pixels may be referred to. In such a manner, with a decrease in size of the current sub-block, overlapping of the pixels referred to in the respective intra prediction modes having adjacent identification numbers increases.

In order to solve this problem, as FIG. 7A and FIG. 7B illustrate, the candidate determining unit 121 determines only the intra prediction modes with the odd numbers as candidate prediction modes from among 35 intra prediction modes. This increases the angle formed by the directions indicated by the adjacent intra prediction modes. As a result, overlapping of the neighboring pixels used in prediction can be reduced. Additionally, the number of intra prediction modes can be limited while maintaining the ratio which values vertical and horizontal lines which are often used in a natural image.

The intra prediction modes may be limited by even numbers instead of odd numbers. Alternatively, intervals between the identification numbers of the intra prediction modes after the limitation may be one or greater.

The candidate determining unit 121 may dynamically determine the types and the number of m intra prediction modes determined as the candidate prediction modes.

### SUMMARY

As described above, the image encoding apparatus 100 according to the present embodiment is an image encoding apparatus 100 which encodes an input image. The image encoding apparatus 100 includes: the picture dividing unit 102 which divides a current block to be encoded in the input image into a plurality of sub-blocks; and the intra prediction unit 109 which performs intra prediction on the plurality of sub-blocks generated by the dividing unit 102 on a per-sub-block basis. The intra prediction unit 109 includes: the size determining unit 120 which determines whether or not a current sub-block to be predicted has a size less than or equal to a predetermined size; the candidate determining unit 121 which determines m intra prediction modes as candidate prediction modes when the candidate determining unit 121 determines that the current sub-block has a size less than or equal to the predetermined size, m being a natural number greater than or equal to 1, the m intra prediction modes being less than M intra prediction modes predefined independently of the size of the current sub-block, M being a natural number greater than of equal to 2; and a prediction unit 122 which selects one intra prediction mode from among the candidate prediction modes determined by the candidate determining unit 121 and performs intra prediction on the current sub-block using the selected one intra prediction mode.

Accordingly, the image encoding apparatus 100 is capable of limiting the number of available intra prediction modes when the size of the current sub-block is small, such as 4×4 pixels. When the size of the sub-block is small, adjacent intra prediction modes produce approximately the same prediction values. Hence, even if the number of available intra prediction modes is limited, the amount of processing required for intra prediction is reduced without significantly reducing the coding efficiency. Specifically, since the image encoding apparatus 100 according to the present disclosure limits the number of available intra prediction modes from M to m, the amount of processing required for intra prediction using M−m intra prediction modes can be reduced.

As described above, the candidate determining unit 121 determines, as candidate prediction modes, m intra prediction modes having identification numbers at equally spaced intervals. Accordingly, available intra prediction modes can be determined with a simple control method when the size of the current sub-block is small. Additionally, the number of intra prediction modes can be limited while maintaining the ratio which values vertical and horizontal lines which are often used in a natural image. Hence, independently of the features of an input image, the amount of processing required for intra prediction can be reduced without significantly reducing the coding efficiency.

### Variations of Embodiment

Methods of limiting the number of intra prediction modes different from the one described above will be described below with reference to the drawings.

### Variation 1

When the size determining unit 120 determines that the size of the current sub-block is less than or equal to a predetermined size, the candidate determining unit 121 according to Variation 1 determines, as candidate prediction modes, m intra prediction modes including at least m−2 intra prediction modes having prediction directions at equally spaced angles.

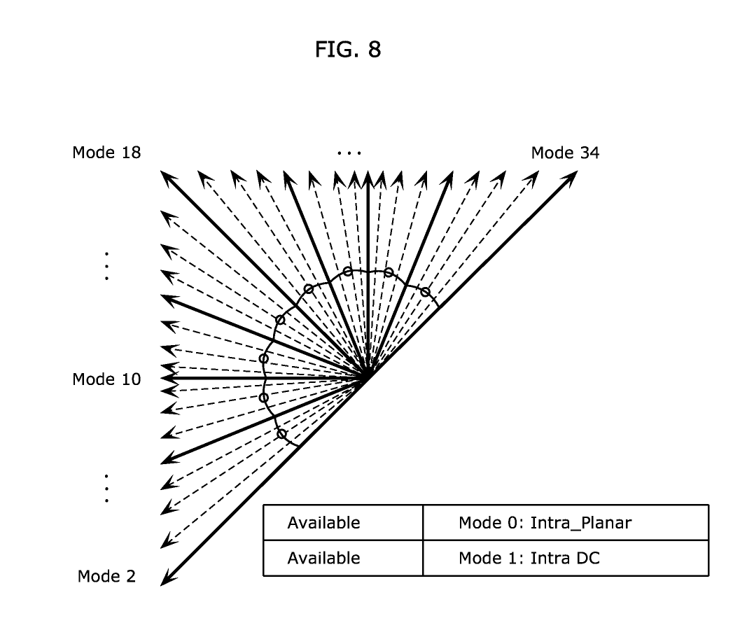

FIG. 8 is a diagram for illustrating an operation for limiting the number of intra prediction modes with angles formed by prediction directions according to Variation 1 of Embodiment.

The HEVC defines 33 intra prediction modes (direction prediction modes) having different prediction directions. The candidate determining unit 121 determines, as candidate prediction modes, m intra prediction modes including at least m−2 direction prediction modes having prediction directions at equally spaced angles.

For example, as FIG. 8 illustrates, the candidate determining unit 121 determines 11 intra prediction modes as candidate prediction modes, namely, 9 direction prediction modes determined from among 33 direction prediction modes, DC prediction mode, and Planar prediction mode. Specifically, the candidate determining unit 121 determines 9 direction prediction modes such that each of the angles formed by the prediction directions of adjacent intra prediction modes is about 22.5 degrees. In other words, the candidate determining unit 121 determines at least m−2 direction prediction modes such that the angles formed by adjacent intra prediction modes are equal.

In this way, even when the number of candidate prediction modes (the value of m) is limited, the intra prediction modes after the limitation cover all directions. This means that one or more intra prediction modes in a specific direction range is always available.

The angle formed by the directions of the intra prediction modes may be greater than or less than about 22.5 degrees. With an increase in angle, the number of available intra prediction modes decreases. In other words, the amount of encoding an output code may increase with a decrease in prediction accuracy, but the amount of processing required for intra prediction can be reduced. On the other hand, with a decrease in angle, the number of available intra prediction modes increases. In other words, although the amount of processing required for intra prediction increases, decrease in prediction accuracy reduces the amount of encoding of an output code.

### Variation 2

When the size determining unit 120 determines that the size of the current sub-block to be predicted is less than or equal to a predetermined size, the candidate determining unit 121 according to Variation 2 determines, as candidate prediction modes, m intra prediction modes including Planar prediction mode and DC prediction mode.

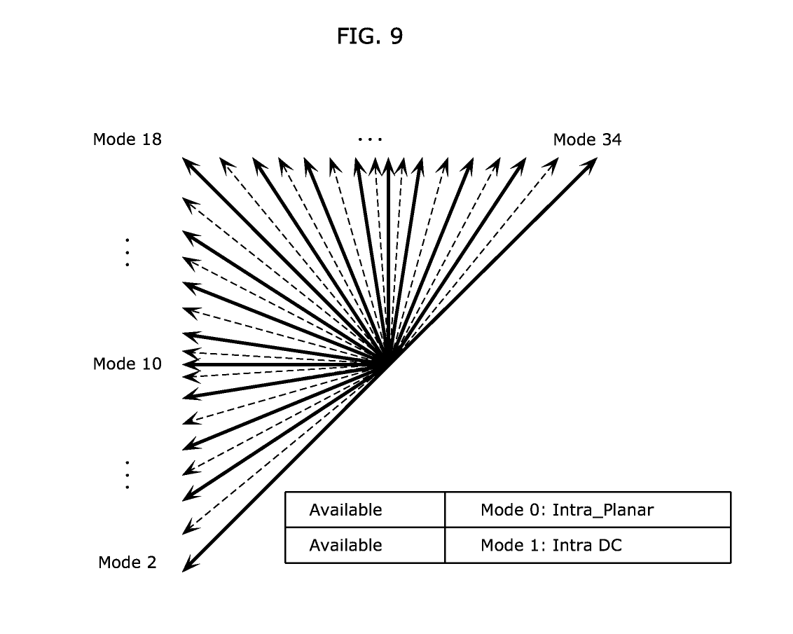

FIG. 9 is a diagram for illustrating an operation for limiting the number of intra prediction modes to make Planar prediction mode and DC prediction mode available according to Variation 2.

The HEVC defines Planar prediction mode and DC prediction mode other than 33 direction prediction modes. For example, when the number of intra prediction modes is limited simply based on the identification numbers, DC prediction mode may be unavailable as FIG. 7B illustrates.

As FIG. 9 illustrates, the candidate determining unit 121 determines m intra prediction modes including Planar prediction mode and DC prediction mode as candidate prediction modes such that the Planar prediction mode and the DC prediction mode are available. Accordingly, the present disclosure is applicable to an image having features which cannot be dealt with by the modes which depend on prediction directions. In other words, the amount of processing required for intra prediction can be reduced without significantly reducing the prediction accuracy.

The candidate determining unit 121 according to Variation 2 may determine the remaining m−2 intra prediction modes other than the Planar prediction mode and the DC prediction mode in any manner. For example, the candidate determining unit 121 may determine the remaining m−2 intra prediction modes having identification numbers at equally spaced intervals as candidate prediction modes. Alternatively, the candidate determining unit 121 may determine the remaining m−2 intra prediction modes having prediction directions at equally spaced angles as candidate prediction modes.

### Variation 3

When the size determining unit 120 determines that the size of the current sub-block to be predicted is less than or equal to a predetermined size, the candidate determining unit 121 according to Variation 3 determines, as candidate prediction modes, m intra prediction modes including intra prediction modes having horizontal and vertical prediction directions.

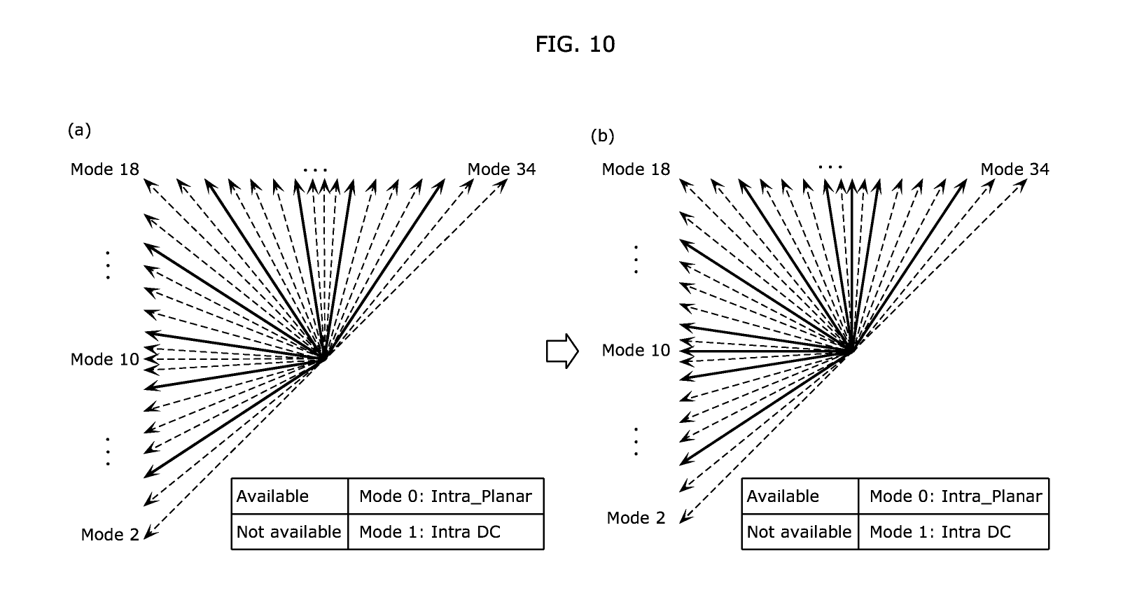

FIG. 10 illustrates an operation for limiting the number of intra prediction modes to make horizontal and vertical prediction modes available according to Variation 3.

For example, when the number of intra prediction modes is limited simply based on the identification numbers, as (a) of FIG. 10 illustrates, the intra prediction modes having horizontal or vertical prediction directions may be unavailable as candidate prediction modes.

As (b) of FIG. 10 illustrates, the candidate determining unit 121 determines m intra prediction modes including horizontal and vertical prediction directions as candidate prediction modes such that the intra prediction modes having the horizontal and vertical prediction directions are available. Accordingly, the amount of processing required for intra prediction can be reduced without significantly reducing the prediction accuracy of an artificial image including many vertical and horizontal lines.

The candidate determining unit 121 according to Variation 3 may determine the remaining m−2 intra prediction modes other than the intra prediction modes having horizontal and vertical prediction directions in any manner. For example, the candidate determining unit 121 may determine the remaining m−2 intra prediction modes having identification numbers at equally spaced intervals as candidate prediction modes. Alternatively, the candidate determining unit 121 may determine the remaining m−2 intra prediction modes having prediction directions at equally spaced angles as candidate prediction modes.

### Variation 4

When the size determining unit 120 determines that the size of the current sub-block to be predicted is less than or equal to a predetermined size, the candidate determining unit 121 according to Variation 4 determines, as candidate prediction modes, m intra prediction modes based on frequency information indicating frequency of use of intra prediction modes.

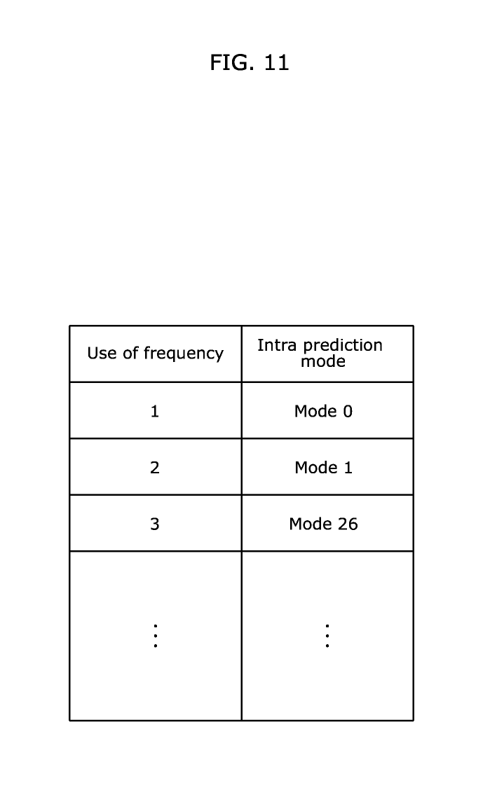

FIG. 11 is a diagram for illustrating an operation for limiting the number of intra prediction modes based on frequency of use of intra prediction modes according to Variation 4. FIG. 11 illustrates a table of intra prediction modes with mode numbers (identification numbers) ordered from higher uses of frequency. In the example in FIG. 11, mode 0 indicates the most frequently used intra prediction mode, and frequency of use decreases in the order from mode 1 to mode 26.

The candidate determining unit 121 includes, for example, a memory, and holds data indicating frequency of use of intra prediction modes as illustrated in FIG. 11. Such data is generated before the current block is encoded or before intra prediction is performed on the current sub-block. For example, in order to generate data indicating frequency of use (frequency information), various types of moving images are experimentally encoded and the use state of intra prediction modes are studied. The data (frequency information) is then generated as a list which associates the frequency of use and intra prediction modes based on the study result.

The candidate determining unit 121 determines, as candidate prediction modes, m intra prediction modes including a plurality of intra prediction modes indicating directions near the prediction direction of an intra prediction mode with high frequency of use, for example, based on the data (frequency information). This determines general features of an image, allowing the number of intra prediction modes to be limited accordingly. Moreover, images may be classified into groups when experimentally encoding various moving images, so that the limiting method can be used according to the features of the image if the image to be encoded corresponds to any one of the groups.

Moreover, the candidate determining unit 121 may determine, as candidate prediction modes, m intra prediction modes ranging from the most frequently used intra prediction mode to the m-th frequency used intra prediction mode. The candidate determining unit 121 need not use the frequency information to determine all of the m intra prediction modes. In other words, the candidate determining unit 121 may determine, based on the frequency information, k(1≦k<m) intra prediction modes out of m intra prediction modes to be determined as candidate prediction modes, and determine m−k intra prediction modes in any other methods. For example, the candidate determining unit 121 may determine, as candidate prediction modes, k intra prediction modes ranging from the most frequently used intra prediction mode to the k-th frequently used intra prediction mode, and m−k intra prediction modes having identification numbers at equally spaced intervals.

The frequency information may be dynamically updated. For example, the candidate determining unit 121 may store frequency of use of the intra prediction modes which have been used into frequency information on a per input-image, a current-block or a current-sub-block basis. The candidate determining unit 121 may then determine m intra prediction modes as candidate prediction modes based on the stored frequency information, for example, on a per current-sub-block basis.

### Variation 5

When the size determining unit 120 determines that the size of the current sub-block to be predicted is less than or equal to a predetermined size, the candidate determining unit 121 according to Variation 5 determines, as candidate prediction modes, m intra prediction modes based on edge information indicating an edge included in at least one of an input image, a current block to be encoded, or a current sub-block to be predicted. The edge information indicates, for example, edge position, edge direction, and edge strength.

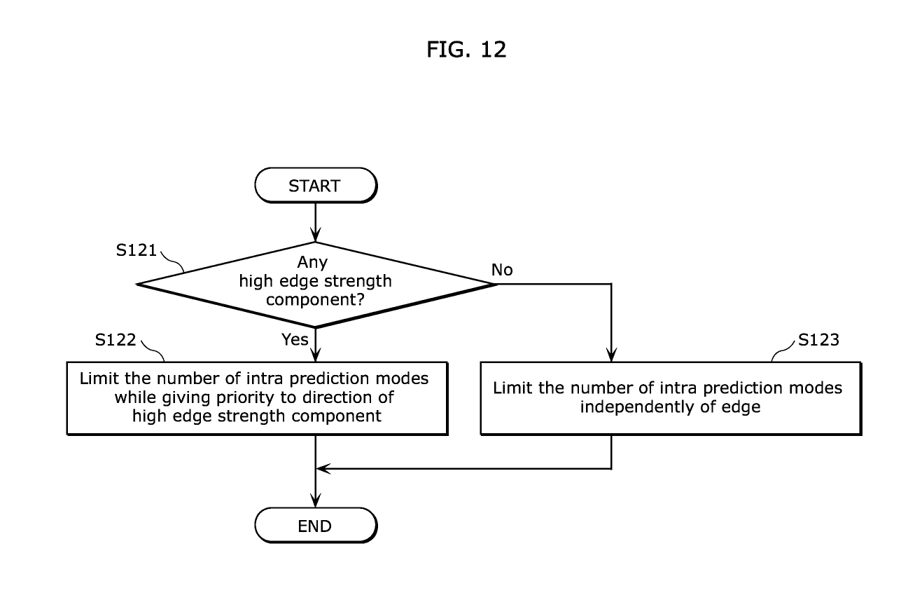

FIG. 12 is a flowchart of an operation for limiting the number of intra prediction modes based on an edge according to Variation 5.

The candidate determining unit 121 limits the number of intra prediction modes while giving priority to prediction directions based on edge strength and determination results of directions with high edge strength components, for example, per sub-block. Specifically, first, the candidate determining unit 121 detects edge strength in an image of the current sub-block and extracts the directions with high strength components (S121).

When there is a high edge strength component (Yes in S121), the candidate determining unit 121 limits the number of intra prediction modes while giving priority to the high edge strength component. Specifically, the candidate determining unit 121 limits the number of intra prediction modes so as to include the direction prediction mode having a prediction direction closest to the direction of the high edge strength component, and an intra prediction mode having features similar to the direction prediction mode. More specifically, the candidate determining unit 121 determines, as candidate prediction modes, m intra prediction modes including the direction prediction mode having a prediction direction closest to the high edge strength component and a direction prediction mode adjacent to the direction prediction mode.

On the other hand, when there is no high edge strength component (No in S121), the candidate determining unit 121 limits the number of intra prediction modes independently of edges (S123). Specifically, the candidate determining unit 121 limits the number of intra prediction modes based on, for example, the methods according to Embodiment and Variations 1 to 4.

In this way, the candidate determining unit 121 efficiently limits the number of intra prediction modes on a per-sub-block basis. Additionally, since the number of intra prediction modes is limited based on the edge direction, the accuracy of intra prediction can be increased, leading to an increase in coding efficiency.

Moreover, it may be that only the level of edge strength is detected and the number of prediction directions available in a sub-block having high edge strength is not reduced. In other words, in the case of a sub-block in which an edge with strength higher than a predetermined level is detected, the candidate determining unit 121 may determine M intra prediction modes as candidate prediction modes. On the other hand, in the case of a sub-block in which an edge with strength lower than a predetermined level is detected or in which no edge is detected, the candidate determining unit 121 may determine m intra prediction modes as candidate prediction modes. For example, the candidate determining unit 121 may limit the number of intra prediction modes based on, for example, the methods according to Embodiment and Variations 1 to 4. In this way, the candidate determining unit 121 may determine m intra prediction modes based on the position and strength of the edge independently of the edge direction.

Moreover, the candidate determining unit 121 may obtain edge information and determine m intra prediction modes based the obtained edge information not on a per sub-block basis, but on a per current block or input image basis. In other words, the candidate determining unit 121 may determine m intra prediction modes as candidate prediction modes based on the features of an image in an input image, a current block, or a current sub-block.

### Variation 6

When the size determining unit 120 determines that the size of the current sub-block to be predicted is less than or equal to a predetermined size, the candidate determining unit 121 according to Variation 6 determines, as candidate prediction modes, m intra prediction modes having different combinations reference pixels referred to by each pixel in a current sub-block. For example, when the reference pixels p(a) and p(b) in (Equation 2) are the same pixel in adjacent intra prediction modes, the candidate determining unit 121 determines m intra prediction modes including at least one of the adjacent intra prediction modes as candidate prediction modes.

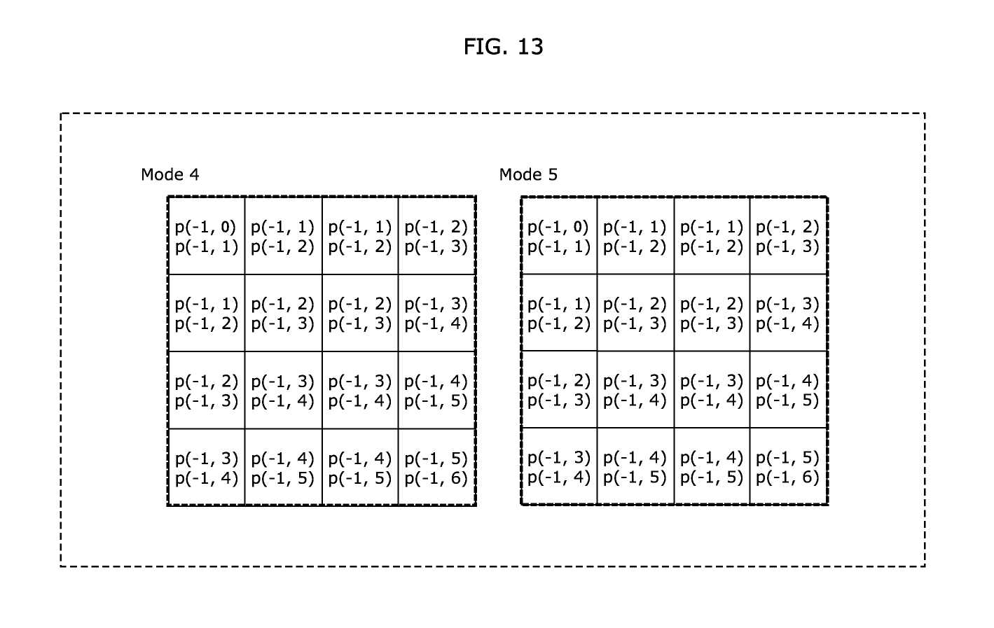

FIG. 13 illustrates combinations of reference pixels used in two intra prediction modes according to Variation 6. FIG. 13 illustrates reference pixels in intra prediction modes of mode 4 and mode 5 as an example.

As FIG. 13 illustrates, the same reference pixels are used in all of the pixels in the sub-block of 4×4 pixels in mode 4 and mode 5. The candidate determining unit 121 restricts use of one of such two intra prediction modes. In other words, the candidate determining unit 121 makes, for example, the intra prediction mode of mode 4 unavailable among two intra prediction modes of mode 4 and mode 5 which use the same reference pixels.

In the case where the same reference pixels are used in two intra prediction modes, the prediction images corresponding to the two intra prediction modes are approximately the same. Accordingly, the amount of processing required for intra prediction can be reduced by making one of the two intra prediction modes unavailable. In this manner, the number of intra prediction modes can be efficiently limited based on the overlapping reference pixels.

The candidate determining unit 121 determines, as candidate prediction modes, m intra prediction modes having different combinations of reference pixels referred to by each pixel in a current sub-block. Here, the combinations of reference pixels in any one of the remaining M−m intra prediction modes are, for example, the same as those in one of the m intra prediction modes determined as candidate prediction modes.

In this way, the candidate determining unit 121 determines, as candidate prediction modes, m intra prediction modes which are equal to an appropriate number of intra prediction modes in which combinations of reference pixels do not overlap and various combinations of reference pixels are available. This can reduce the amount of processing required for intra prediction without significantly reducing the prediction accuracy.

When the size determining unit 120 determines that the size of the current sub-block to be predicted is less than or equal to a predetermined size, the candidate determining unit 121 may determine, as candidate prediction modes, m intra prediction modes in which part of reference pixels referred to by each pixel in a current sub-block is different. For example, when adjacent direction prediction modes have the same reference pixels referred to by some pixels, the candidate determining unit 121 may restrict use of one of the adjacent direction prediction modes if it is determined to be efficient. For example, the candidate determining unit 121 may determine that the above restriction is efficient when the same reference pixels are used in eight pixels or more in 4×4 pixels.

When the size determining unit 120 determines that the size of the current sub-block to be predicted is less than or equal to a predetermined size, the candidate determining unit 121 may determine, as candidate prediction modes, m intra prediction modes having different reference pixels referred to by a bottom-right-most pixel in the current sub-block. In other words, the candidate determining unit 121 limits the number of intra prediction modes based on a pixel located farthest from neighboring pixels of the current sub-block.

The bottom-right-most pixel in the current sub-block is a pixel which has least overlapping of reference pixels among the pixels in the sub-block.

In this way, the processing for checking all pixels in the sub-block is eliminated. Additionally, the limitation based on the bottom-right-most pixel leads to increased possibility of overlapping of reference pixels in many pixels in a sub-block to be processed. This allows the number of inter prediction modes to be efficiently limited.

In a case where a prediction value is obtained using one reference pixel and (Equation 1) other than the case where a prediction value is obtained using two reference pixels and (Equation 2), the limitation can be made in a similar manner.

When the size determining unit 120 determines that the size of the current sub-block to be predicted is less than or equal to a predetermined size, the candidate determining unit 121 may determine, as candidate prediction modes, m intra prediction modes including one or more intra prediction modes used for prediction of a sub-block adjacent to the current sub-block. For example, the candidate determining unit 121 may determine, as candidate prediction modes, m intra prediction modes including m−1 intra prediction modes determined based on the method according to Embodiment and Variations 1 to 6 and the intra prediction mode used for prediction of an adjacent sub-block.

Adjacent sub-blocks are likely to have similar images, leading to a high possibility of matching of the prediction directions of the intra prediction modes. Accordingly, the amount of processing required for intra prediction can be reduced without significantly reducing the prediction accuracy by making the intra prediction mode used for the prediction of the adjacent sub-block available.

Some of Embodiment and Variations 1 to 6 described above may be combined. Such a combination may allow the candidate determining unit 121 to limit the number of intra prediction modes more efficiently than the case where the limitation is made based on a single condition. For example, modes similar to 4×4 and 8×8 according to H. 264 can be represented by combining the condition (Variation 1) for limiting the number of intra prediction modes based on equally spaced angles of about 22.5 degrees and the condition for limiting the number of intra prediction modes so as to include the Planar prediction mode and the DC prediction mode. This increases the computing speed to approximately the same level as H. 264, and allows the present disclosure to be applicable to any developed technique.

### SUMMARY

As described above, the image encoding apparatus 100 according to Variations of Embodiment may determine, as candidate prediction modes, m intra prediction modes including at least m−2 intra prediction modes having prediction directions at equally spaced angles.

With this, since the angles formed by the intra predictions of m−2 intra prediction modes are equal, the intra prediction modes having prediction directions close to a given direction can be made available. Hence, the amount of processing required for intra prediction can be reduced without significantly reducing the prediction accuracy.

Moreover, in the image encoding apparatus 100, the candidate determining unit 121 may determine, as candidate prediction modes, m intra prediction modes including Planar prediction mode and DC prediction mode.

Accordingly, the Planar prediction mode and the DC prediction mode which do not depend on the prediction directions can be made available. Hence, for example, when an input image has features which cannot be dealt with by directional prediction modes, the amount of processing required for intra prediction can be reduced without significantly reducing the prediction accuracy.

Moreover, in the image encoding apparatus 100, the candidate determining unit 121 may determine, as candidate prediction modes, m intra prediction modes including horizontal and vertical prediction directions.

With this, the horizontal and vertical intra prediction modes can be used. Hence, for example, when an input image is an artificial image including many vertical and horizontal lines, the amount of processing required for intra prediction can be reduced without significantly reducing the prediction accuracy.

Moreover, in the image encoding apparatus 100, the candidate determining unit 121 may determine, as candidate prediction modes, m intra prediction modes based on frequency information indicating the frequency of use of intra prediction modes.

With this, m intra prediction modes are determined based on the frequency information. Accordingly, by associating the features of an image and frequency of use of intra prediction modes, m intra prediction modes can be determined appropriately according to the features of the image. Hence, the amount of processing required for intra prediction can be reduced without significantly reducing the prediction accuracy.

Moreover, in the image encoding apparatus 100, the candidate determining unit 121 may determine, as candidate prediction modes, m intra prediction modes based on edge information indicating an edge included in at least one of an input image, a current block to be encoded, or a current sub-block to be predicted.

With this, m intra prediction modes are determined based on the edge information. Accordingly, for example, when an edge greater than a predetermined level is detected, m intra prediction modes are determined appropriately. For example, the candidate determining unit 121 can make intra prediction modes suitable to the features of an image available, by determining m intra prediction modes so as to include many intra prediction modes having prediction directions near the edge direction. Hence, the amount of processing required for intra prediction can be reduced without significantly reducing the prediction accuracy.

Moreover, in the image encoding apparatus 100, the candidate determining unit 121 may determine, as candidate prediction modes, m intra prediction modes having different combinations of reference pixels referred to by each pixel in a current sub-block.

With this, when intra prediction is performed with intra prediction modes having the same combinations of reference pixels, similar prediction images are likely to be generated. Accordingly, the amount of processing required for intra prediction can be reduced without significantly reducing the prediction accuracy by making each of m intra prediction modes have different combinations of reference pixels.

Moreover, in the image encoding apparatus 100, the candidate determining unit 121 may determine, as candidate prediction modes, m intra prediction modes having different reference pixels referred to by a bottom-right-most pixel in the current sub-block.

The bottom-right-most-pixel in the current sub-block is a pixel which has least overlapping of reference pixels among the pixels in the sub-block. Accordingly, the amount of processing required for intra prediction can be reduced without significantly reducing the prediction accuracy by avoiding overlapping of reference pixels used in prediction of such bottom-right-most pixel.

Moreover, in the image encoding apparatus 100, the candidate determining unit 121 may determine, as candidate prediction modes, m intra prediction modes including an intra prediction mode used for prediction of a sub-block adjacent to the current sub-block to be predicted.

Adjacent sub-blocks are likely to have similar images, leading to a high possibility of matching of the prediction directions of the intra prediction modes. Accordingly, the amount of processing required for intra prediction can be reduced without significantly reducing the prediction accuracy, by making the intra prediction mode used for the adjacent sub-block available.

As described above, the amount of processing required for intra prediction can be reduced without significantly reducing the coding efficiency in any case.

In the above embodiment and Variations 1 to 6, the candidate determining unit 121 may change the number of intra prediction modes available before the limitation according to the resolution of an input image. Specifically, it may be that M1 intra prediction modes are available when the resolution of an input image is a first size, and M2 intra prediction modes are available when the resolution of an input image is a second size less than the first size. Here, M1 and M2 are natural numbers greater than or equal to 2, and satisfy the relation of M1<M2≦M.

For example, when the resolution of an input image is 1920×1080 pixels, the candidate determining unit 121 determines m intra prediction modes as candidate prediction modes from among M1 intra prediction modes, instead of from among M intra prediction modes predefined independently of the block size. On the other hand, when the resolution of an input image is 920×720 pixels, the candidate determining unit 121 determines m intra prediction modes as candidate prediction modes from among M2 intra prediction modes instead of M intra prediction modes predefined independently of the block size.

As the method for determining m intra prediction modes as candidate prediction modes from among M1 or M2 intra prediction modes, for example, methods described in Embodiment and Variations 1 to 6 may be used. As described above, the number of intra prediction modes can be limited from M to M1 or M2 according to the resolution of an input image, and the number of intra prediction modes can be limited from M1 or M2 to m according to the size of the current sub-block to be predicted.

Such a configuration allows the number of intra prediction modes to be limited while reducing the influence of the amount of processing for intra prediction which increases with an increase in resolution.

### Other Embodiments

The above Embodiment and Variations 1 to 6 have been described as examples of the technique according to the present application. However, the technique according to the present disclosure is not limited to the above examples, but the technique is also applicable to embodiments to which changes, replacements, additions, omissions, etc. have been made. Moreover, the structural elements described in the above Embodiment and Variations 1 to 6 may be combined into a new embodiment.

Embodiment and Variations 1 to 6 have been described above as examples of the technique according to the present disclosure. For this purpose, the attached drawings and detailed descriptions have been provided.

Accordingly, the structural elements illustrated in the attached drawings and described in the detailed descriptions include not only structural elements that are essential to solve the problem but also structural elements that are not essential to solve the problem. For this reason, it should not be directly asserted that the non-essential structural elements are essential based on the fact that the non-essential structural elements are illustrated in the attached drawings and are described in the detailed descriptions.

The above embodiment and Variations 1 to 6 are provided as examples of the technique according to the present disclosure, and thus various kinds of changes, replacements, additions, omissions, etc. may be made in the scope of the Claims or the equivalent range.

The image encoding apparatus according to the present disclosure may be an image encoding apparatus which encodes an input image. The image encoding apparatus may include: a dividing unit which divides a current block to be encoded in the input image into a plurality of sub-blocks; and an intra prediction unit which performs intra prediction on the plurality of sub-blocks generated by the dividing unit, on a per-sub-block basis. The intra prediction unit may include: a candidate determining unit which determines m intra prediction modes as candidate prediction modes, m being a natural number greater than or equal to 1, the m intra prediction modes being less than M intra prediction modes predefined independently of the size of the current sub-block, M being a natural number greater than or equal to 2; and a prediction unit which selects one intra prediction mode from among the candidate prediction modes determined by the candidate determining unit and performs intra prediction on the current sub-block with the selected intra prediction mode.

Specifically, in the image encoding apparatus according to the present disclosure, m intra prediction modes are predefined as candidate prediction modes. For example, the intra prediction unit can use only m intra prediction modes independently of the type of an input image, such as a still image, a moving image, a natural image, or a text image, and independently of the size of the encoding processing unit, such as the size of the current block to be encoded or the size of the current sub-block to be predicted. In other words, in any intra predictions, the intra prediction unit selects one of the predetermined m intra prediction modes, and performs intra prediction using the selected intra prediction mode.

In such a manner, m intra prediction modes out of M intra prediction modes defined according to the coding standard may be determined as available candidate prediction modes independently of the type of an input image and the size of the encoding processing unit. This allows the amount of processing required for intra prediction to be reduced independently the type of an input image.

Moreover, the candidate determining unit may determine, as candidate prediction modes, different number of intra prediction modes according to the resolution of an input image from among M intra prediction modes defined according to the coding standard.

Specifically, the candidate determining unit may determine M1 intra prediction modes as candidate prediction modes when the resolution of an input image is a first size (for example, 1920×1080 pixels). Specifically, the candidate determining unit may select M2 intra prediction modes as candidate prediction modes when the resolution of an input image is a second size (for example, 920×720 pixels) less than the first size. Here, M1 and M2 are natural numbers greater than or equal to 2, and satisfy the relation of M1<M2≦M.

As described, the candidate determining unit determines the candidate prediction modes according to the resolution of an input image independently of the size of the encoding processing unit, such as the size of the current block to be encoded or the current sub-block to be predicted. This allows the number of intra prediction modes to be limited while reducing the influence of the amount of processing for intra prediction which increases with an increase in resolution.

Each of the structural elements of the image encoding apparatus 100 according to the present disclosure (the picture buffer 101, the picture dividing unit 102, the subtracting unit 103, the prediction residual encoding unit 104, the coefficient code generating unit 105, the prediction residual decoding unit 106, the adding unit 107, the prediction image generating unit 108, the intra prediction unit 109, the loop filter 110, the frame memory 111, the inter prediction unit 112, the selecting unit 113, the quantization value determining unit 114, the header code generating unit 115, the size determining unit 120, the candidate determining unit 121, and the prediction unit 122) may be implemented by a software such as a program executed on a computer including a central processing unit (CPU), a RAM, a read only memory (ROM) communication interface, an I/O port, a hard disk, a display and the like, or by a hardware such as an electronic circuit.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present disclosure is applicable to an image encoding apparatus which limits the number of intra prediction modes based on the size of a sub-block to be intra predicted. Specifically, the present disclosure is applicable to, for example, a recorder, a digital camera, and a tablet terminal device.

1. An image encoding apparatus which encodes an input image, the image encoding apparatus comprising:
a dividing unit configured to divide a current block to be encoded in the input image into a plurality of sub-blocks; and
an intra prediction unit configured to perform intra prediction on the plurality of sub-blocks generated by the dividing unit, on a per-sub-block basis,
wherein the intra prediction unit includes:
a size determining unit configured to determine whether or not a current sub-block to be predicted among the plurality of sub-blocks has a size less than or equal to a predetermined size;
a candidate determining unit configured to determine m intra prediction modes as one or more candidate prediction modes when the size determining unit determines that the current sub-block has the size less than or equal to the predetermined size, m being a natural number greater than or equal to 1, the m intra prediction modes being less than M intra prediction modes predefined independently of the size of the current sub-block, M being a natural number greater than or equal to 2; and
a prediction unit configured to: select one intra prediction mode from among the one or more candidate prediction modes determined by the candidate determining unit; and perform intra prediction on the current sub-block using the one intra prediction mode selected.

2. The image encoding apparatus according to claim 1,
wherein the candidate determining unit is configured to determine, as the one or more candidate prediction modes, the m intra prediction modes having identification numbers at equally spaced intervals.

3. The image encoding apparatus according to claim 1,
wherein the candidate determining unit is configured to determine the m intra prediction modes including at least m−2 intra prediction modes as the one or more candidate prediction modes, the m−2 intra prediction modes having prediction directions at equally spaced angles.

4. The image encoding apparatus according to claim 1,
wherein the candidate determining unit is configured to determine, as the one or more candidate prediction modes, the m intra prediction modes including an intra prediction mode having a horizontal prediction direction and an intra prediction mode having a vertical prediction direction.

5. The image encoding apparatus according to claim 1,
wherein the candidate determining unit is configured to determine, as the one or more candidate prediction modes, the m intra prediction modes including a Planar prediction mode and a DC prediction mode.

6. The image encoding apparatus according to claim 1,
wherein the candidate determining unit is configured to determine the m intra prediction modes as the one or more candidate prediction modes based on edge information indicating an edge included in at least one of the input image, the current block, or the current sub-block.

7. The image encoding apparatus according to claim 1,
wherein the candidate determining unit is configured to determine, as the one or more candidate prediction modes, the m intra prediction modes having different combinations of reference pixels referred to by each pixel in the current sub-block.

8. The image encoding apparatus according to claim 1,
wherein the candidate determining unit is configured to determine, as the one or more candidate prediction modes, the m intra prediction modes having different reference pixels referred to by a bottom-right most pixel in the current sub-block.

9. The image encoding apparatus according to claim 1,
wherein the candidate determining unit is configured to determine the m intra prediction modes as the one or more candidate prediction modes based on frequency information indicating a frequency of use of each of the M intra prediction modes.

10. The image encoding apparatus according to claim 1,
wherein the candidate determining unit is configured to determine, as the one or more candidate prediction modes, the m intra prediction modes including an intra prediction mode used for prediction of a sub-block adjacent to the current sub-block.

11. The image encoding apparatus according to claim 1,
wherein the predetermined size is 4×4 pixels.

12. An image encoding method for encoding an input image, the image encoding method comprising:
dividing a current block to be encoded in the input image into a plurality of sub-blocks; and
performing intra prediction on the plurality of sub-blocks generated in the dividing, on a per-sub-block basis,
wherein the performing includes:
determining whether or not a current sub-block to be predicted among the plurality of sub-blocks has a size less than or equal to a predetermined size;
determining m intra prediction modes as one or more candidate prediction modes when the current sub-block is determined to have the size less than or equal to the predetermined size, m being a natural number greater than or equal to 1, the m intra prediction modes being less than M intra prediction modes predefined independently of the size of the current sub-block, M being a natural number greater than or equal to 2; and
selecting one intra prediction mode from among the m candidate prediction modes determined in the determining of m intra prediction modes, and performing intra prediction on the current sub-block using the one intra prediction mode selected.
